(19) United States
(12) Patent Application Publication
(10) Pub. No.: US 2006/0026388 A1
(43) Pub. Date: Feb. 2, 2006

(54) Computer executing instructions having embedded synchronization points

(76) Inventors: Alan H. Karp, Palo Alto, CA (US); Rajiv Gupta, Los Altos, CA (US)

Correspondence Address: HEWLETT-PACKARD COMPANY;Intellectual Property Administration, P.O. Box 272400, Fort Collins, CO, 80527-2400, US

(21) Appl. No.: 10/902,156

(22) Filed: Jul. 30, 2004

(51) Int. Cl. G06F 9/00

(52) U.S. Cl. 712/24; 712/220

(57) ABSTRACT

A computer operable to execute instructions having embedded synchronization points includes a first program counter and a second program counter. The computer also includes a synchronization unit electrically coupled to the first and second program counters. When a synchronization point is reached, the synchronization unit is operable to stall the first or second program counter.

### TECHNICAL FIELD

The technical field relates to the field of computers. More particularly, the technical field relates to a computer executing instructions having embedded synchronization points.

### BACKGROUND

Computers today are designed with many different types of architectures. One type of architecture uses several execution units. The instructions executed by this architecture typically include several steps, each to be performed by one of the execution units. One such architecture is typically referred to as a Very-Long Instruction Word Computer Architecture or VLIW. VLIW computers execute a number of instructions in parallel using the execution units. However, instances arise where one execution unit must stall to wait for a condition. For example, a read from a memory location on a hard disk drive takes much longer than a simple addition or comparison of two numbers. In these cases, all execution units must stall to wait for the execution unit performing the read. This delay lowers the performance of the entire VLIW computer.

### SUMMARY

A computer operable to execute instructions having embedded synchronization points includes a first program counter and a second program counter. The computer also includes a synchronization unit electrically coupled to the first and second program counters. When a synchronization point is reached, the synchronization unit is operable to stall the first or second program counter.

### BRIEF DESCRIPTION OF THE DRAWINGS

The embodiments are illustrated by way of example and not limitation in the accompanying figures in which like numeral references refer to like elements, and wherein:

FIG. 1 shows a block diagram of a computer executing instructions having embedded synchronization points, according to an embodiment;

FIG. 2 shows a flow diagram of method for executing instructions having embedded synchronization points, according to an embodiment; and

FIGS. 3A-B show an example of instructions containing embedded synchronization points, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

Throughout the present disclosure, reference is made to synchronization points and a synchronization unit. The synchronization points are markers or indicators inserted or embedded in executable code generated by a compiler. The executable code may include any number of sets of instructions to be executed in parallel by a like number of blocks of execution units. The sets of instructions may be executed independently of one another with a few exceptions. The markers or indicators denote the exceptions. For example, the markers or indicators may denote a point where both a first set of instructions and a second set of instruction access the same location in memory, such as a read and a write to the same memory location. In another example, the markers or indicators may denote a point where data from a first register file for the first set of instructions must be moved to or obtained from a second register file for the second set of instructions. In these cases, an error will occur if execution of the first and second set of instructions is not synchronized. The synchronization points mark this occurrence so that the synchronization unit may handle the exception without error.

The synchronization unit monitors the execution of the first and second set of instructions. When a synchronization point is encountered, the synchronization unit checks to see if a program counter for the first set of instructions is equal to a program counter for the second set of instructions. That is, the synchronization unit checks the instruction count for each set of instruction to determine if they are equal. If the instruction counts are equal, both sets of instructions are synchronized and the synchronization unit allows the instructions to continue execution. If one instruction count is higher than the other instruction count, the synchronization unit halts execution of the set of instructions with the higher instruction count until the set of instructions with the lower instruction count synchronizes. That is, execution is halted until both program counters are equal.

In an example, a computer is configured to run at least two sets of instructions in parallel. The computer includes at least two register files, at least two sets of execution units, at least two program counters and a synchronization unit. One of the program counters, register files and set of execution units runs one set of instructions while the other program counter, register file and set of execution units runs the other set of instruction. Both sets of instructions run independently of one another such that if one set of execution units is stalled the other may continue.

Situations may arise, however, when both sets of instruction must be synchronized. Therefore, a synchronization point is embedded into both sets of instructions by a compiler. The synchronization unit monitors the instructions as they are executed for occurrences of these synchronization points. When a synchronization point is discovered, the synchronization unit checks both program counters to determine if they are equal. If equal, the synchronization unit continues to monitor the instructions and execution continues in both blocks of execution units. If unequal, the synchronization unit determines which program counter is smaller or which block of execution units has the lower instruction count. That block of execution units is allowed to continue running while the other block of execution units is stalled until both program counters are equal.

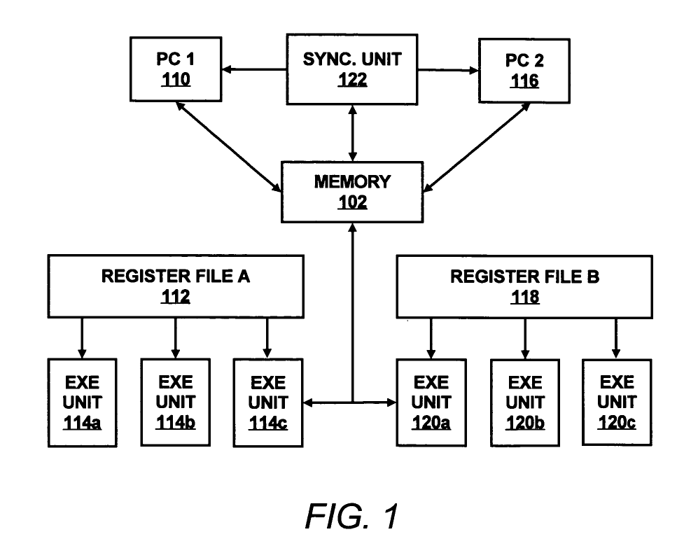

With reference first to FIG. 1, there is shown a block diagram of an embodiment of a computer 100 executing instructions having embedded synchronization points. The computer 100 includes a first program counter 110, a first register file 112 and a first block of execution units 114a-114c. The computer 100 also includes a second program counter 116, a second register file 118 and a second block of execution units 120a-120c. The first program counter 110, the first register file 112 and the first block of execution units 114a-114c work together to execute a first set of instructions while the second program counter 116, the second register file 118 and the second block of execution units 120a-120c work together to execute a second set of instruction simultaneously and in parallel. The first register file 112 stores data for the instructions executed by the first block of execution units 114a-114c, and the second register file 112 stores data for the instructions executed by the second block of execution units 120a-120c

The first set of instructions and the second set of instructions are stored in the memory 102. The memory 102 may include RAM, buffers, etc., such as known in the art. For example, the first set of instructions may be initially stored in RAM and then stored in a buffer waiting to be executed by the first block of execution units 114a-114c. Similarly, the memory 102 stores the second set of instructions waiting to be executed by the second block of execution units 120a-120c.

The computer 100 also includes a synchronization unit 122 in communication with the memory 102 and the program counters 110 and 116. The synchronization unit 122 monitors the memory 102 for instructions having embedded synchronization points. If a synchronization point is discovered, the synchronization unit 122 compares the program counters 112 and 118 to determine if they are equal. If they are equal, the synchronization unit 122 continues monitoring the first and second set of instructions stored in the memory 102. If they are not equal, the synchronization unit 122 lets the set of instructions with the lower program counter run until both program counters 110 and 116 are equal thus synchronizing both sets of instructions. The synchronization unit 122 may include a comparator for comparing the program counters 110 and 112 to determine whether they are equal when a synchronization point is reached. The comparator may also be used to determine which of the program counters 110 and 112 is higher when a synchronization point is reached to determine which program counter to stall.

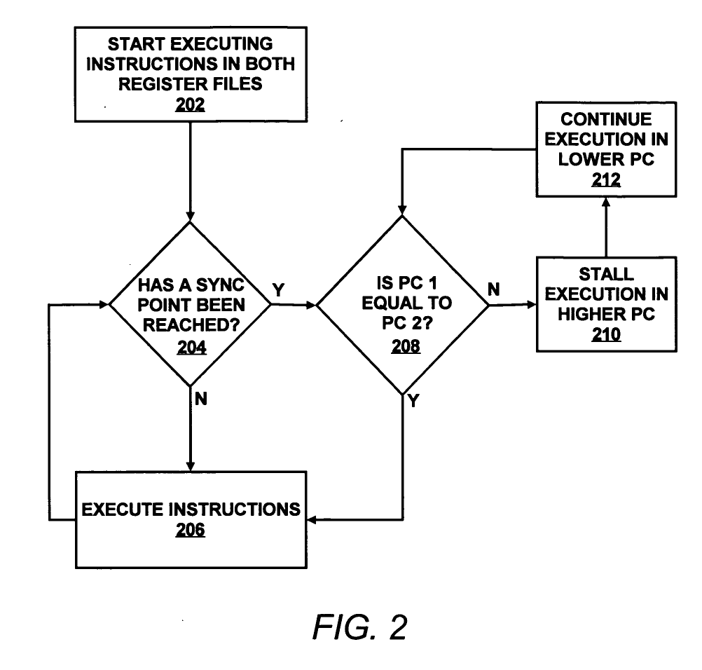

FIG. 2 shows a flow diagram of an embodiment of a method 200 for the computer 100. The flow diagram depicts an example of steps performed by the computer 100 to execute instructions having embedded synchronization points. The following description of the operational mode 200 is made with reference to the computer 100 illustrated in FIG. 1, and thus makes reference to the elements cited therein.

In the method 200, the first and second block of execution units 114a-114c and 120a-120c, shown in FIG. 1, start to execute a first set of instructions and a second set of instructions respectively at step 202. The synchronization unit 122 checks instructions from each set of instructions to determine if any synchronization point has been reached at step 204. If no synchronization point has been reached, the first and second block of execution units 114a-114c and 120a-120c continue to execute instructions at step 206. However, if a synchronization point is reached, the synchronization unit 122 checks to see of the first program counter 110 is equal to the second program counter 116 at step 208. If equal, execution of the first set of instructions is synchronized with the second set of instructions and execution in both the first and second block of execution units 114 and 120 may continue. That is, flow control returns to step 206. If the program counters 110 and 116 are not equal, the synchronization unit 122 stalls execution of instructions in the block of execution units having the higher program counter at step 210. Execution of instruction in the block of execution units having the lower program counter continues at step 212. At this point, flow control returns to step 208. Thus, steps 208, 210, and 212 are repeated until the program counter having the lower instruction count is increased to equal the program counter initially determined to have the higher instruction count. Then, execution of both instruction sets proceeds at step 206.

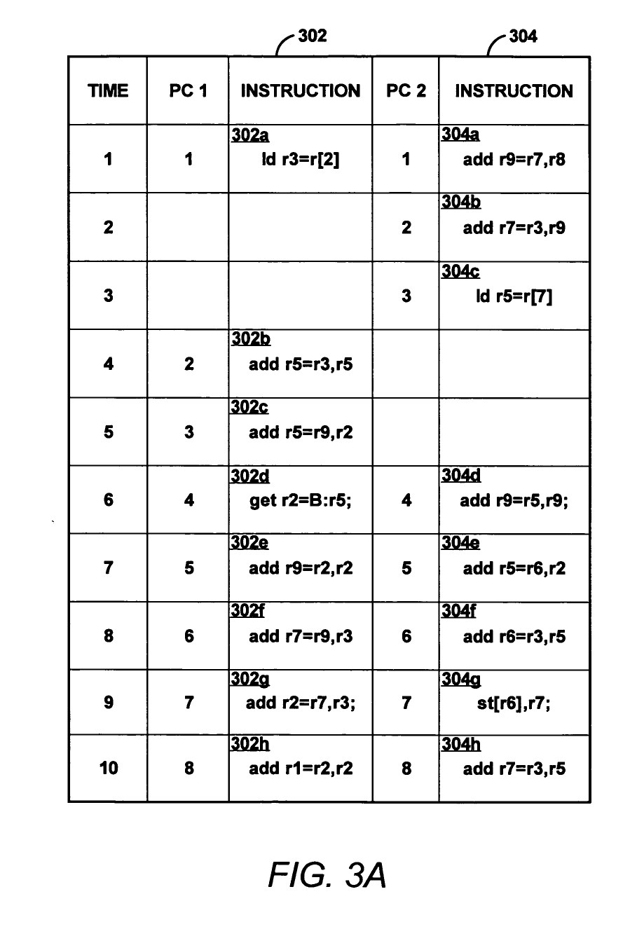

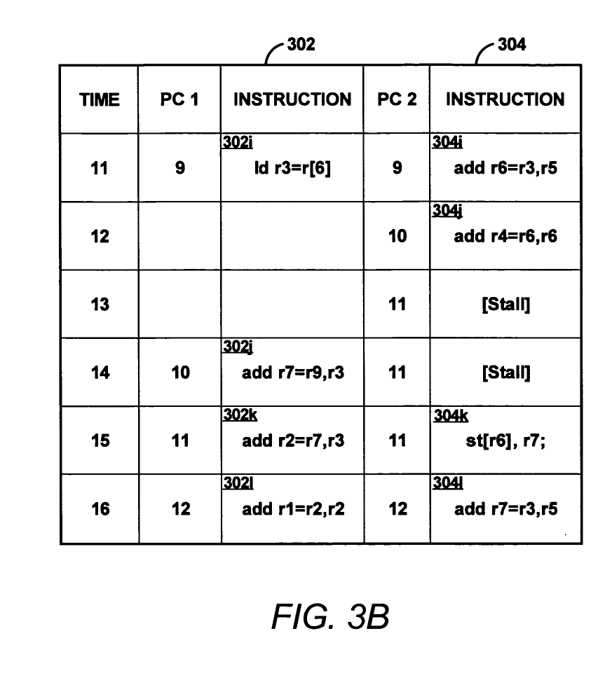

FIGS. 3A-B show an example of two sets of instructions for execution on the computer 100. The first set of instructions 302 executes using the first program counter 110, the first register file 112 and the first block of execution units 114. The second set of instructions 304 executes using the second program counter 116, the second register file 118 and the second block of execution units 120. The first three instructions 302a-302c and 304a-304c may run independently from one another and do not include a synchronization point. As shown in FIG. 3, instruction 302a, which includes a load instruction, may take three time units to execute while instructions 304a-304c execute during the same three time units. Similarly, instruction 304c includes a load instruction taking three time units to execute.

The synchronization unit 122 first identifies synchronization points at instructions 302d and 304d. That is, the first synchronization points for each instruction set 302 and 304 are reached at instructions 302d and 304d. The synchronization points, for example, are denoted by semicolons in the instructions. The compiler inserts the synchronization points in the instruction sets 302 and 304 based on the requirements of the instructions. For example, the compiler may insert a synchronization point at instruction 302d to insure that the correct value is loaded in register r5, such as performed by instruction 304c, before getting the contents of the register r5. Similarly, before performing the add operation of instruction 304d, instruction 302c must be performed. Thus, a synchronization point is added at instruction 304d. If the synchronization points were not added at instructions 302d and 304d, an error is generated in the form of incorrect values being used in the operations designated by instructions 302d and 304d.

Because the program counters are equal at instructions 302d and 304d when the synchronization points are reached, the execution units 114a-114c and 120a-120c are not stalled. FIG. 3B illustrates an example where execution units are stalled. The next synchronization point is reached at instruction 304k. For example, the store operation at instruction 304k may require the add operation for r7 be performed before storing the contents of r7 at the memory location r6, such as performed by instruction 304k.

Thus, at instruction 304k the execution units 120a-c are stalled. That is, a synchronization point is reached and the program counters 1 and 2 are not equal, assuming instruction 304k is ready to be executed at time unit 13. As shown in FIG. 3B, the program counter 2 for instruction set 304 is at 11 and the program counter 1 for the instruction set 302 is at 9. Thus, the program counter 2 is stalled, because it has the higher value. The program counter 2 remains stalled until the program counters 1 and 2 are equal at time unit 15. Then, execution of the instruction set 304 resumes.

What has been described and illustrated herein are the embodiments. The terms, descriptions and figures used herein are set forth by way of illustration only and are not meant as limitations. Those skilled in the art will recognize that many variations are possible within the spirit and scope of the embodiments, which intended to be defined by the following claims and their equivalents in which all terms are meant in their broadest reasonable sense unless otherwise indicated.

What is claimed is:

1. A computer operable to execute instructions having embedded synchronization points, the computer comprising:
a first program counter;
a second program counter; and
a synchronization unit electrically coupled to the first and second program counters, wherein the synchronization unit is operable to stall the first or second program counter when a synchronization point is reached.

2. The computer of claim 1, further comprising:
a first block of execution units operable to execute a first set of instructions using the first program counter; and
a second block of execution units operable to execute a second set of instructions using the second program counter.

3. The computer of claim 2, further comprising:
a first register file operable to store data for the first set of instructions executed by the first block of execution units; and
a second register file operable to store data for the second set of instructions executed by the second block of execution units.

4. The computer of claim 2, wherein the synchronization point is provided in at least one of the first set of instructions and the second set of instructions.

5. The computer of claim 4, wherein the synchronization point is provided in at least one of the first set of instructions and the second set of instructions when moving data between the first and second register files is needed or writing data to a memory location is needed.

6. The computer of claim 3, wherein the synchronization point designates a point where concurrent execution of the instructions using the first register file and the instructions using the second register file generates an error if execution of the instructions using the first register file and execution of the instructions using the second register file is not synchronized.

7. The computer of claim 1, wherein the synchronization unit further comprises a comparator operable to compare values stored in the first and second program counters.

8. A method of operating a processor having a first and second program counter, the method comprising:
executing a first set of instructions using the first program counter;
executing a second set of instructions concurrently with the execution of the first set of instructions using the second program counter;
determining whether the first and second set of instructions need synchronization; and
synchronizing the execution of the first and second set of instructions if the first and second set of instructions need synchronization.

9. The method of claim 8, wherein determining whether the first and second set of instructions need synchronization further comprises:
determining whether a synchronization point is reached in the first set of instructions or the second set of instructions.

10. The method of claim 9, wherein determining whether the first and second set of instructions need synchronization further comprises:
determining whether the first program counter is equal to the second program counter in response to reaching the synchronization point; and
stalling execution of the first set of instructions or the second set of instructions in response to the program counters not being equal.

11. The method of claim 10, wherein stalling execution of the first set of instructions or the second set of instructions in response to the program counter not being equal comprises:
stalling execution of the set of instructions associated with the program counter having a higher instruction count.

12. The method of claim 11, wherein stalling execution of the first set of instructions or the second set of instructions in response to the program counter not being equal comprises:
executing the non-stalled set of instructions until the first program counter and the second program counter are equal.

13. The method of claim 11, further comprising:
unstalling execution of the stalled set of instructions in response the first program counter and the second program becoming equal.

14. The method of claim 9, further comprising:
inserting synchronization points in the first set of instructions and the second set of instructions.

15. The method of claim 9, further comprising:
writing data to a memory location in response to the synchronization point being reached.

16. A computer, comprising:
means for executing a first set of instructions;
means for executing a second set of instruction concurrently with the first set of instructions;
means for determining if the concurrent execution of the first and second set of instructions will generate an error;
means for stalling the means for executing the first or second set of instructions if the concurrent execution of the first and second set of instructions will generate an error.

17. The computer of claim 16, further comprising means for synchronizing the means for executing the first set of instructions with the means for executing the second set of instructions.

18. The computer of claim 16, further comprising means for determining if the means for executing the first or second set of instructions is stalled.

19. The computer of claim 16, further comprising a first register means for storing data for the means for executing the first set of instructions and a second register means for storing data for the means for executing the second set of instructions.

20. The computer of claim 17, further comprising means for moving data between the first register means and the second register means.
